(19) United States
(12) Patent Application Publication
(10) Pub. No.: US 2016/0157594 A1
(43) Pub. Date: Jun. 9, 2016

(54) CLEANING ASSEMBLY

(71) Applicants: Nick Jones, Kalamazoo, MI (US); Bryan Whitmore, Kalamazoo, MI (US); Lance Matteson, Kalamazoo, MI (US)

(72) Inventors: Nick Jones, Kalamazoo, MI (US); Bryan Whitmore, Kalamazoo, MI (US); Lance Matteson, Kalamazoo, MI (US)

(21) Appl. No.: 14/560,167

(22) Filed: Dec. 4, 2014

(51) Int. Cl. A46B 5/04; B26B 21/00

(52) U.S. Cl. CPC A46B 5/04; B26B 21/00

(57) ABSTRACT

A cleaning assembly for protecting a finger while cleaning razor blades includes a sleeve that may be worn on the finger. The sleeve protects the finger while cleaning razor blades. The sleeve has a top end, a bottom end and an outer wall extending therebetween. The sleeve has a length between 5 cm and 8 cm. A plurality of bristles is coupled to the sleeve. The bristles may remove debris from between the razor blades.

### BACKGROUND OF THE DISCLOSURE

1. Field of the Disclosure

The disclosure relates to cleaning devices and more particularly pertains to a new cleaning device for protecting a finger while cleaning razor blades.

2. Summary of the Disclosure

An embodiment of the disclosure meets the needs presented above by generally comprising a sleeve that may be worn on a finger. The sleeve protects the finger while cleaning razor blades. The sleeve has a top end, a bottom end and an outer wall extending therebetween. The sleeve has a length between 5 cm and 8 cm. A plurality of bristles is coupled to the sleeve. The bristles may remove debris from between the razor blades.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a left side view of a cleaning assembly according to an embodiment of the disclosure.

FIG. 2 is a front view of an embodiment of the disclosure.

FIG. 3 is a back view of an embodiment of the disclosure.

FIG. 4 is a perspective view of an embodiment of the disclosure.

FIG. 5 is an in-use view of an embodiment of the disclosure.

### DESCRIPTION OF THE PREFERRED EMBODIMENT

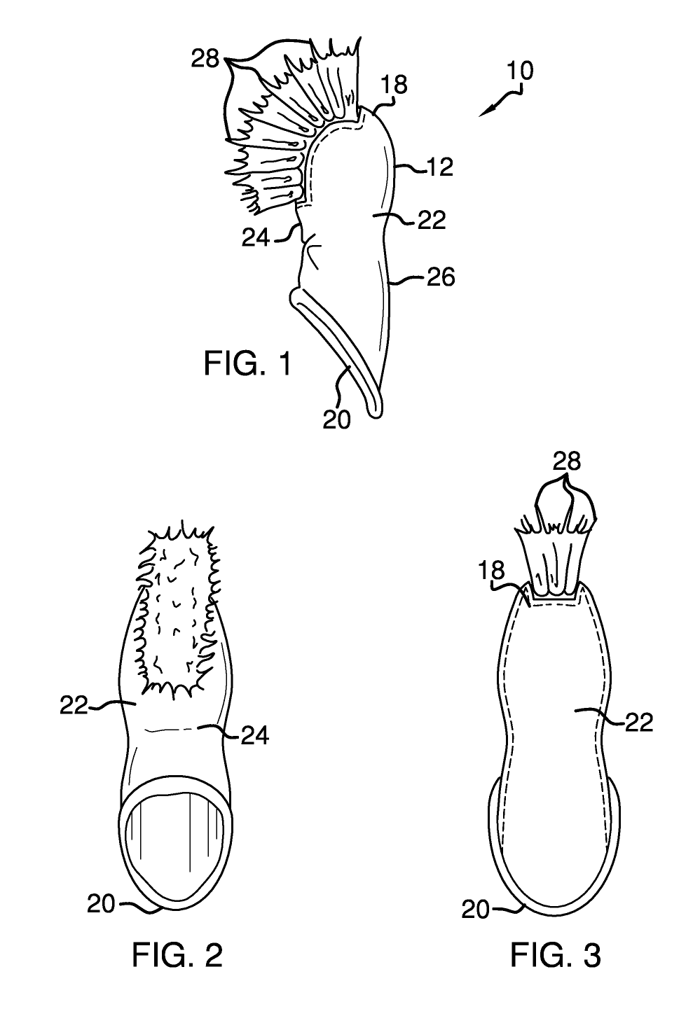

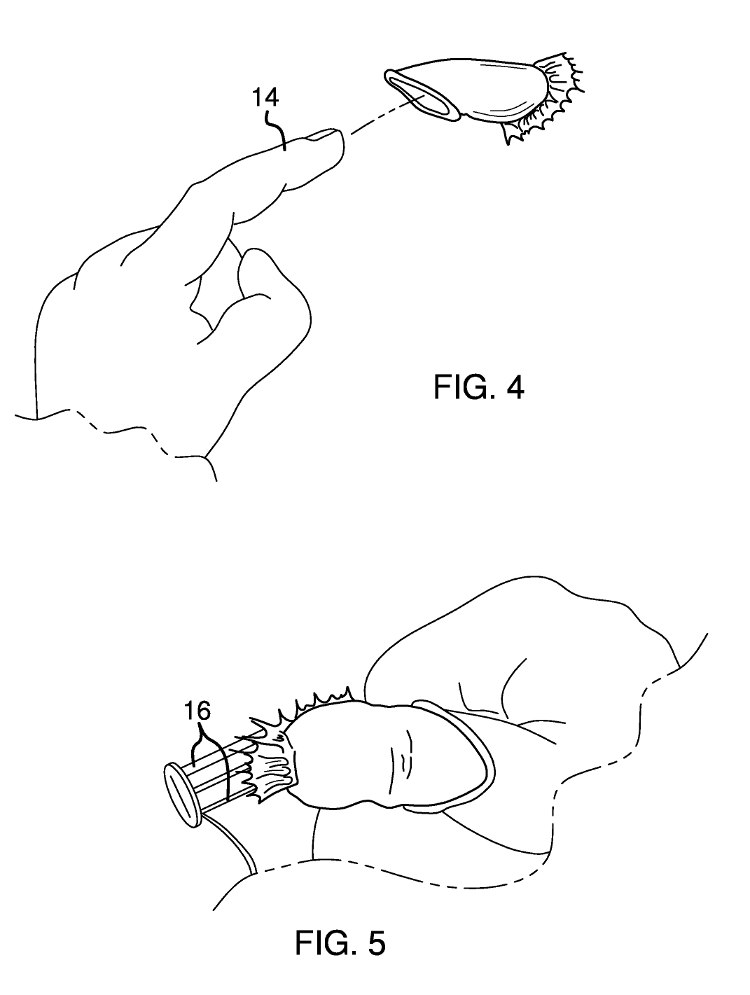

With reference now to the drawings, and in particular to FIGS. 1 through 5 thereof, a new cleaning device embodying the principles and concepts of an embodiment of the disclosure and generally designated by the reference numeral 10 will be described.

As best illustrated in FIGS. 1 through 5, the cleaning assembly 10 generally comprises a sleeve 12 that may be worn on a finger 14. The sleeve 12 protects the finger 14 while cleaning razor blades 16. The sleeve 12 may be comprised of a woven material that is resistant to being cut. The razor blades 16 may be of any conventional design.

The sleeve 12 has a top end 18, a bottom end 20 and an outer wall 22 extending therebetween. The outer wall 22 has a first side 24 and a second side 26. The top end 18 is closed. The bottom end 20 is open to insertably receive the finger 14.

The outer wall 22 is curvilinear, giving the sleeve 12 a tubular shape. The bottom end 20 slopes upwardly between the second side 26 and the first side 24. The bottom end 20 may be gripped at the second side 26 to facilitate the sleeve 12 being pulled onto the finger 14. The sleeve 12 may have a length between 5 cm and 8 cm.

A plurality of bristles 28 is coupled to the sleeve 12. The bristles 28 may remove debris from between the razor blades 16. The bristles 28 are coupled to and extend laterally away from the outer wall 22. The bristles 28 are arranged in a row extending over the top end 18 and downwardly along the first side 24 of the outer wall 22.

In use, the sleeve 12 is positioned over the finger 14. The bristles 28 are urged along an entire length of the razor blades 16. The bristles 28 clean the razor blades 16 to extend a service life of the razor blades.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A cleaning assembly configured to clean razor blades, said assembly comprising:
a sleeve configured to be worn on a finger to facilitate protecting the finger while cleaning razor blades, said sleeve having a top end, a bottom end and an outer wall extending therebetween, said sleeve having a length between 5 cm and 8 cm; and
a plurality of bristles coupled to said sleeve such that said bristles are configured to remove debris from between the razor blades.

2. The assembly according to claim 1, wherein said outer wall having a first side and a second side, said top end being closed, said bottom end being open such that said bottom end is configured to insertably receive the finger.

3. The assembly according to claim 2, wherein said outer wall being curvilinear such that said sleeve has a tubular shape, said bottom end sloping upwardly between said second side and said first side, said bottom end being configured to be gripped at said second side to facilitate said sleeve being pulled onto the finger.

4. The assembly according to claim 1, wherein said bristles being coupled to and extending laterally away from said outer wall.

5. The assembly according to claim 1, wherein:
said outer wall having a first side; and
said bristles being arranged in a row extending over said top end and downwardly along said first side of said outer wall.

6. A cleaning assembly configured to clean razor blades, said assembly comprising:
a sleeve configured to be worn on a finger to facilitate protecting the finger while cleaning razor blades, said sleeve having a top end, a bottom end and an outer wall extending therebetween, said outer wall having a first side and a second side, said top end being closed, said bottom end being open such that said bottom end is configured to insertably receive the finger, said outer wall being curvilinear such that said sleeve has a tubular shape, said bottom end sloping upwardly between said second side and said first side, said bottom end being configured to be gripped at said second side to facilitate said sleeve being pulled onto the finger, said sleeve having a length between 5 cm and 8 cm; and
a plurality of bristles coupled to said sleeve such that said bristles are configured to remove debris from between the razor blades, said bristles being coupled to and extending laterally away from said outer wall, said bristles being arranged in a row extending over said top end and downwardly along said first side of said outer wall.
